(19) United States
(12) Patent Application Publication
(10) Pub. No.: US 2018/0210488 A1
(43) Pub. Date: Jul. 26, 2018

(54) CIRCUIT DEVICE, REAL-TIME CLOCKING DEVICE, ELECTRONIC APPARATUS, AND VEHICLE

(71) Applicant: Seiko Epson Corporation, Tokyo (JP)

(72) Inventors: Hiroshi KIYA, Suwa (JP); Masayuki KAMIYAMA, Chino (JP)

(21) Appl. No.: 15/871,404

(22) Filed: Jan. 15, 2018

(30) Foreign Application Priority Data
Jan. 20, 2017 (JP) 2017-008030

(51) Int. Cl. G06F 1/14

(52) U.S. Cl. CPC G06F 1/14

(57) ABSTRACT

A circuit device includes a processing unit that detects occurrence of an internal event of the circuit device, a storage unit, and a clocking unit that generates clocking data which is real-time clock information on the basis of an oscillation signal generated using a resonator. The processing unit stores specific information on the internal event and the clocking data when the occurrence of the internal event is detected, in the storage unit when the occurrence of the internal event is detected.

### BACKGROUND

### 1. Technical Field

The present invention relates to a circuit device, a real-time clocking device, an electronic apparatus, a vehicle, and the like.

### 2. Related Art

There has been known a real-time clocking device which is operated by a backup power supply, such as a battery, and continuously performs clocking (measuring of a real time) even when a main power supply of a system is turned off. There is a real-time clocking device having a time stamp function of leaving a time stamp by using the occurrence of an external event as a trigger. That is, clocking data (time stamp) at a point in time when a signal indicating the occurrence of the external event is input through a terminal from the outside of the real-time clocking device is recorded in a memory or the like.

Examples of a technique related to an internal event include a technique disclosed in JP-A-2001-228932. In JP-A-2001-228932, a real-time clocking device includes an oscillation stop detection circuit, a power supply voltage drop detection circuit, a storage unit that holds an output of the oscillation stop detection circuit, and a storage unit that holds an output of the power supply voltage drop detection circuit. That is, information on an internal event, such as the stop of oscillation or a drop of a power supply voltage, is stored in the storage unit.

As described above, in JP-A-2001-228932, the occurrence of an event, such as the stop of oscillation or a drop of a power supply voltage, within the real-time clocking device can be stored. However, there is a problem that it is not possible to know the order of occurrence of an internal event. For example, in a case where the cause of occurrence of an event is desired to be specified, unawareness of the order of occurrence of an internal event may result in a concern that the cause of occurrence of an event cannot be specified.

### SUMMARY

An advantage of some aspects of the invention is to provide a circuit device capable of knowing the order of occurrence of an internal event, a real-time clocking device, an electronic apparatus, a vehicle, and the like.

Embodiments of the invention can be implemented as the following configurations.

An aspect of the invention relates to a circuit device including a processing circuit configured to detect occurrence of an internal event of the circuit device, a storage circuit, and a clocking circuit configured to generate clocking data which is real-time clock information based on an oscillation signal, in which the processing circuit stores specific information on the internal event and the clocking data when the occurrence of the internal event is detected, in the storage circuit when the occurrence of the internal event is detected.

According to the aspect of the invention, when the occurrence of the internal event of the circuit device is detected, the specific information on the internal event and the clocking data when the occurrence of the internal event is detected are stored in the storage unit of the circuit device. Thereby, the specific information on the internal event and the clocking data when the occurrence of the internal event is detected can be accumulated in time series. The accumulated information is read out from the storage unit, and thus it is possible to know the order of the occurrence of the internal event.

In the aspect of the invention, in a case where occurrence of an i-th internal event (i is an integer of equal to or greater than 1 and equal to or less than n) among first to n-th internal events (n is an integer of 2 or greater) is detected, the processing circuit may store information for specifying the occurrence of at least the i-th internal event in the storage circuit as the specific information.

In this manner, it is possible to know the order of occurrence of the internal events included in the first to n-th internal events from the specific information and the clocking data which are stored in the storage circuit. It is possible to estimate trouble occurring in the circuit device (or a real-time clocking device including the circuit device) from the order.

In the aspect of the invention, in a case where the j-th internal event (j is an integer of equal to or greater than 1 and equal to or less than n, and is an integer different from i) among the first to n-th internal events occurs after the i-th internal event occurs, the processing circuit may store information for specifying the occurrence of the j-th internal event in a storage region of an address different from an address in which the information for specifying the occurrence of the i-th internal event is stored.

In this manner, when the i-th and j-th internal events have occurred, specific information and time data are stored in different storage regions, and thus it is possible to record in which time series the i-th and j-th internal events have occurred. The external device can specify a time series of the occurrence of the internal events based on the stored data, and can specify the cause of occurrence of the internal events.

In the aspect of the invention, the processing circuit may perform a process of setting whether to store the specific information in the storage circuit in a case where each of the first to n-th internal events occurs.

In this manner, in a case where any internal event among the first to n-th internal events has occurred, it is possible to set an internal event for which specific information and clocking data are stored in the storage circuit and an internal event for which specific information and clocking data are not stored in the storage circuit even when the internal event occurs. That is, it is possible to record time-series information on the occurrence of an event with respect to the event for which the time-series information is desired to be known.

In the aspect of the invention, the first to n-th internal events may include at least two events among events indicating abnormality of a main power supply voltage of the circuit device, abnormality of a backup power supply voltage of the circuit device, and abnormality of an oscillation signal.

In this manner, it is possible to know in which order at least two of the abnormality of the main power supply voltage, the abnormality of the backup power supply voltage, and the abnormality of the oscillation signal have occurred. Thereby, it is possible to estimate trouble (trouble related to a power supply or oscillation) which has occurred in the circuit device from the time-series information thereof.

In the aspect of the invention, the specific information on the internal event may be a flag representing occurrence of the internal event.

In this manner, the pieces of specific information on the internal events can be realized by the flags indicating whether or not the internal events have occurred. It is detected that the flags are set to be in an active state, and thus the processing circuit can detect the occurrence of the internal events. In this case, the flags and clocking data are stored in the storage circuit, and thus it is possible to store the specific information and time data in the storage circuit.

In the aspect of the invention, the circuit device may further include an interface circuit configured to output the specific information and the clocking data of an address, which is designated by address designation from an external device, to the external device.

In this manner, the external device has access to the storage circuit through the interface circuit, and thus it is possible to acquire specific information on the occurrence of the internal events and clocking data. Thereby, it is possible to estimate the cause of occurrence of the internal events based on time-series information on the occurrence of the internal events.

In the aspect of the invention, the storage circuit may include a register and a memory, and the processing circuit may write the specific information in the register in a case where the occurrence of the internal event is detected and may transmit the specific information written in the register to the memory.

In this manner, when the occurrence of the internal event is detected, specific information on the internal event at that point in time can be taken in the register. The specific information taken in the register is transmitted to the memory together with the time data, and thus the specific information and the time data at a point in time when the occurrence of the internal event is detected can be stored in the storage circuit.

In the aspect of the invention, the processing circuit may perform a process of setting whether to transmit the specific information from the register to the memory in a case where any internal event among the first to n-th internal events (n is an integer of 2 or greater) occurs.

A process of setting whether to store the specific information on the internal event and the clocking data in the storage circuit in a case where any internal event occurs is realized by such transmission processing from the register to the memory.

Another aspect of the invention relates to a real-time clocking device including any one of the circuit devices described above and a resonator.

Still another aspect of the invention relates to an electronic apparatus including any one of the circuit devices described above.

Still another aspect of the invention relates to a vehicle including any one of the circuit devices described above.

### BRIEF DESCRIPTION OF THE DRAWINGS

The invention will be described with reference to the accompanying drawings, wherein like numbers reference like elements.

FIG. 1 illustrates a configuration example of a circuit device according to this exemplary embodiment.

FIG. 2 illustrates a detailed configuration example of the circuit device according to this exemplary embodiment.

FIG. 3 is a flow chart illustrating a procedure of a process of storing time-series information on the occurrence of an internal event.

FIG. 4 illustrates an example of a flag stored in a register.

FIG. 5 illustrates an example of clocking data which is generated by a clocking data generation unit and is held.

FIG. 6 illustrates an example of a flag and clocking data which are stored in a memory.

FIG. 7 illustrates an example of specific information on an internal event and an example of a state indicated by the specific information.

FIG. 8 illustrates a configuration example of a real-time clocking device.

FIG. 9 illustrates a configuration example of an electronic apparatus.

FIG. 10 illustrates a configuration example of a vehicle.

### DESCRIPTION OF EXEMPLARY EMBODIMENTS

Hereinafter, a preferred exemplary embodiment of the invention will be described in detail. Meanwhile, this exemplary embodiment described below is not unduly limited to the contents of the invention described in the appended claims, and all configurations described in this exemplary embodiment are not necessarily essential as solving means of the invention.

### 1. Circuit Device

As described above, in the related art of a real-time clocking device, the occurrence of an internal event is stored. For example, in a case where the internal event of which the occurrence is stored is the stop of oscillation or a drop of a power supply voltage, an oscillation stop flag and a power supply voltage drop flag are stored as occurrence information on the internal events. For example, the oscillation stop flag is “0” in a case where oscillation is normal, and the oscillation stop flag is “1” in a case where the stop of oscillation is detected. The power supply voltage drop flag is “0” in a case where a power supply voltage is normal, and the power supply voltage drop flag is “1” in a case where the drop of a power supply voltage is detected.

When an external device such as a CPU reads out the flag from the real-time clocking device, the flag stored at that point in time is read out, and thus information on an internal event occurring later than the point in time of the read-out of the flag is obtained. For example, in a case where the stop of oscillation and a drop of a power supply voltage have occurred, the oscillation stop flag of “1” and the power supply voltage drop flag of “1” are read out.

However, it is not possible to know the order of occurrence of the stop of oscillation and the drop of a power supply voltage from the information, and thus there is a possibility that it is not possible to specify the cause of occurrence of an internal event. For example, in a case where the oscillation stop flag of “1” and the power supply voltage drop flag of “1” are read out, it is possible to consider a possibility that oscillation is stopped after a power supply voltage drops and a possibility that a power supply voltage drops after oscillation is stopped due to a failure of an oscillation circuit, or the like. In a case where only the flags are stored, it is not possible to know the order thereof, and thus it is not possible to know detailed information on the failure. For example, it is not possible to know whether the stop of oscillation has occurred due to a drop of a power supply voltage or another cause (a failure of the oscillation circuit, or the like).

For example, in a case where any trouble has occurred in examination to be performed when a system having the real-time clocking device embedded therein is manufactured, the contents of the trouble may be desired to be known. For example, in a case where the stop of oscillation is detected in the examination, a method of coping with the trouble varies depending on the cause of the stop of oscillation such as a mounting failure, a failure of the oscillation circuit, or a simple drop of a power supply voltage. For example, power supply noise is easily generated, such as during the mounting of a battery which is a backup power supply of the real-time clocking device, and oscillation may be stopped due to the power supply noise. In this case, a difficulty in distinguishment from amounting failure, a failure of the oscillation circuit, or the like results in a possibility that coping with the trouble becomes complicated.

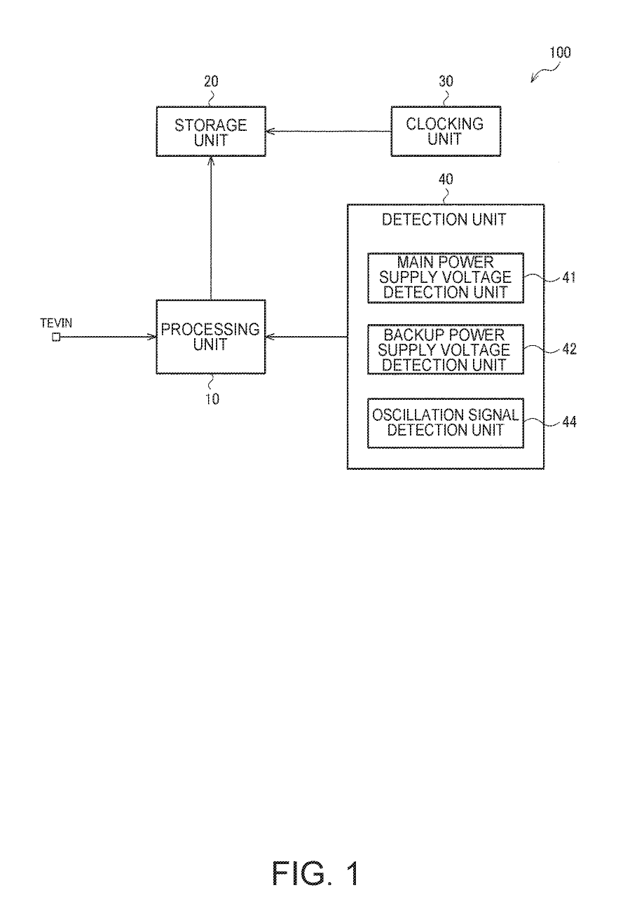

FIG. 1 illustrates a configuration example of a circuit device according to this exemplary embodiment capable of solving the above-described problem. A circuit device 100 includes a processing unit 10, a storage unit 20, and a clocking unit 30. In addition, the circuit device 100 may include a detection unit 40 and a terminal TEVIN. The circuit device 100 can be realized by, for example, an integrated circuit device. For example, the configuration of FIG. 1, an oscillation circuit, and a resonator are combined with each other to configure a real-time clocking device. Meanwhile, this exemplary embodiment is not limited to the configuration of FIG. 1, and various modifications such as the omission of a portion of the components and the addition of other components can be made thereto.

The processing unit 10 detects the occurrence of an internal event of the circuit device 100. The clocking unit 30 generates clocking data which is real-time clock information on the basis of an oscillation signal generated using the resonator. When the occurrence of the internal event is detected, the processing unit 10 stores specific information on the internal event and clocking data when the occurrence of the internal event is detected in the storage unit 20.

The internal event refers to an event occurring inside the circuit device 100 (or the real-time clocking device). Specifically, the internal event refers to an event in which a detected signal indicating the occurrence of the event is generated inside the circuit device 100. The processing unit 10 is notified of the occurrence of the internal event by the detected signal, and detects the occurrence of the internal event. On the other hand, an external event refers to an event in which a detected signal indicating the occurrence of the event is generated outside (for example, a sensor or the like) the circuit device 100 (or the real-time clocking device). The detected signal is input to the processing unit 10 through the terminal TEVIN of the circuit device 100, and the processing unit 10 detects the occurrence of the external event.

The specific information on the internal event refers to information for specifying whether or not the internal event has occurred. Specifically, the specific information is information indicating whether the internal event has occurred later than a point in time when the specific information is stored in the storage unit 20. For example, in a case where specific information on a plurality of internal events is stored, each internal event includes information for specifying whether or not the internal event has occurred. That is, it is possible to know which internal event among the plurality of internal events has occurred by viewing the specific information.

Clocking data is data indicating a time as real-time clock information. That is, the clocking data is data of a time measured by the clocking unit 30 as real-time clock information. For example, the clocking data is data indicating a date and time, and may include calendar data and time data. For example, the calendar data is data such as year, month, week, and day, and the time data is data such as hour, minute, and second. For example, the clocking unit 30 performs frequency division of the oscillation signal to generate clock signals in cycles of one second, and measures a time by counting the clock signals.

Each of the processing unit 10 and the clocking unit 30 is realized by a logic circuit. For example, the processing unit 10 and the clocking unit 30 may be configured as an integrated logic circuit (gate array). Examples of the storage unit 20 to be adopted may include a memory such as a RAM, various storage elements such as a register, and a storage circuit.

According to this exemplary embodiment, when the occurrence of an internal event is detected, specific information on the internal event and clocking data when the occurrence of the internal event is detected are stored in the storage unit 20. That is, whenever the internal event occurs, specific information on the internal event at that time is stored, and time-series information on the occurrence of the internal event is accumulated. Thereby, an external device (for example, a processing device or the like) which is provided outside the real-time clocking device has access to the storage unit 20, so that it is possible to acquire the time-series information on the occurrence of the internal event. It is possible to know in which order the internal events have occurred on the basis of the time-series information, and thus it is possible to specify (estimate) the cause of occurrence of the internal event. For example, in a case where the oscillation stop flag is “0” and the power supply voltage drop flag is “1” at a certain date and time and the oscillation stop flag is “1” and the power supply voltage drop flag is “1” at the subsequent date and time, it is possible to estimate that oscillation has been stopped due to a drop of a power supply voltage.

In addition, in this exemplary embodiment, in a case where the occurrence of an i-th internal event, among first to n-th internal events, has been detected, the processing unit 10 stores information for specifying at least the occurrence of the i-th internal event in the storage unit 20 as specific information on the internal event. Here, n is an integer of 2 or greater. In addition, i is an integer of equal to or greater than 1 and equal to or less than n.

That is, in a case where any internal event among the plurality of internal events has occurred, the processing unit 10 stores information for specifying at least the occurrence of the internal event in the storage unit 20 together with clocking data when the occurrence of the internal event is detected. The specific information stored at this time is information indicating whether or not each internal event has occurred, for example, with respect to all of the first to n-th internal events. Alternatively, the specific information is information indicating whether or not each internal event of some internal events (including the internal event) of the first to n-th internal events has occurred. That is, the stored specific information may include at least information for specifying the occurrence of the internal event.

In this manner, it is possible to know in which order the internal events included in the first to n-th internal events have occurred, from the specific information and the clocking data which are stored in the storage unit 20. It is possible to estimate trouble having occurred in the circuit device 100 (real-time clocking device) from the order. For example, it is possible to estimate the cause of occurrence of (at least a portion of) the internal events among the first to n-th internal events.

In addition, in this exemplary embodiment, in a case where the j-th internal event among the first to n-th internal events has occurred after the i-th internal event has occurred, the processing unit 10 stores information for specifying the occurrence of the j-th internal event in a storage region of an address different from an address in which information for specifying the occurrence of the i-th internal event is stored. Here, j is an integer of equal to or greater than 1 and equal to or less than n, and is an integer different from i.

That is, in a case where the i-th internal event has occurred at a certain date and time (first date and time, first timing), the processing unit 10 stores time data at that point in time and specific information on the internal event in a storage region of a first address of the storage unit 20. In a case where the j-th internal event has occurred at a date and time (second date and time, second timing) later than the date and time, time data at that point in time and specific information on the internal event are stored in a storage region of a second address of the storage unit 20. The second address is an address different from the first address.

In this manner, when the i-th and j-th internal events have occurred, specific information and time data are stored in different storage regions, and thus it is possible to record in which time series the i-th and j-th internal events have occurred. The external device can specify a time series of the occurrence of the internal events on the basis of the stored data, and can specify the cause of occurrence of the internal events.

In addition, in this exemplary embodiment, the processing unit 10 performs a process of setting whether to store specific information in the storage unit 20 in a case where each internal event among the first to n-th internal events has occurred.

That is, the processing unit 10 stores specific information and time data in the storage unit 20 in a case where some internal events (for example, the above-described i-th and j-th internal events) among the first to n-th internal events have occurred, and does not store specific information and time data in the storage unit 20 in a case where the other internal events (for example, the k-th internal event; k is an integer different from i and j equal to or greater than 1 and equal to or less than n) have occurred. The processing unit 10 performs setting processing for designating (setting) the above-described some internal events and the other internal events. For example, the processing unit performs the setting processing on the basis of the setting of a register from the external device, or the like. Alternatively, the processing unit performs the setting processing on the basis of setting information recorded in a non-volatile memory, a fuse, or the like which is not shown in the drawing. Meanwhile, the processing unit may further perform the setting processing for setting whether to store specific information (including specific information on an external event) and time data in the storage unit 20 in a case where the external event has occurred.

In this manner, in a case where any internal event among the first to n-th internal events has occurred, it is possible to control whether to store specific information and clocking data in the storage unit 20. That is, it is possible to record time-series information on the occurrence of an event with respect to the event for which the time-series information is desired to be known. For example, unnecessary time-series information is not recorded, and thus it is possible to reduce the storage region (for example, the capacity of the memory) of the storage unit 20.

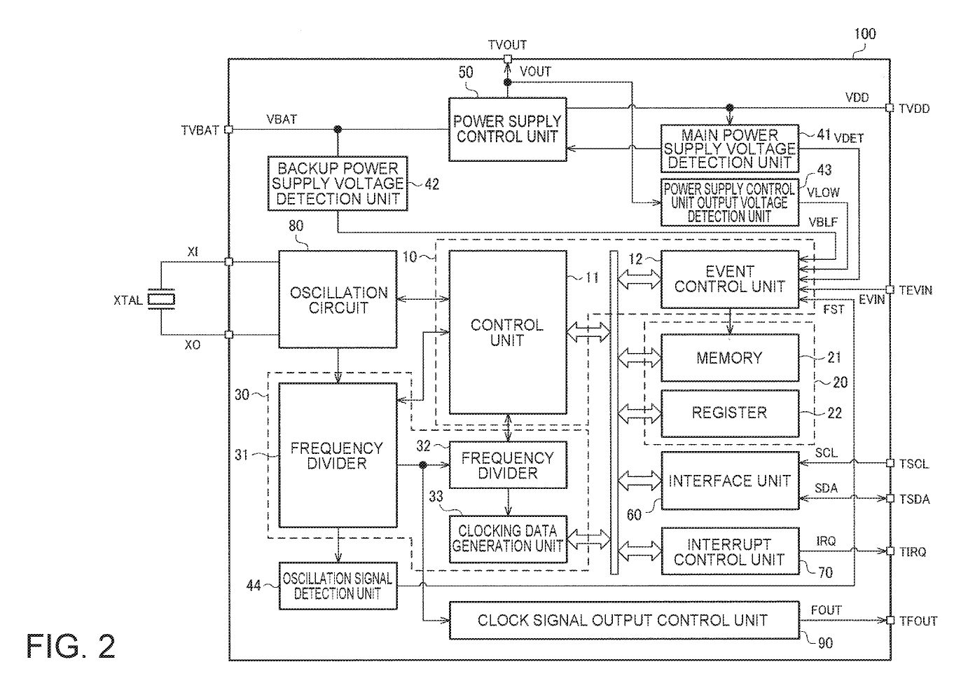

More specifically, the storage unit 20 includes a register and a memory (for example, a memory 21 and a register of FIG. 2). The processing unit 10 writes specific information on an internal event in the register in a case where the occurrence of the internal event is detected, and transmits the specific information written in the register to the memory.

The register of the storage unit 20 is updated by new specific information whenever the occurrence of an internal event is detected. The specific information is transmitted to a storage region of the memory having a different address (for example, the above-described first and second addresses) for each transmission. That is, time-series information on the occurrence of the internal event is stored in the memory. Meanwhile, time data is held in, for example, the register (or a counter itself for clocking) of the clocking unit 30, and the time data is transmitted to the memory together with the above-described specific information.

In this manner, when the occurrence of the internal event is detected, specific information on the internal event at that point in time can be taken in the register. The specific information taken in the register is transmitted to the memory together with the time data, and thus the specific information and the time data at a point in time when the occurrence of the internal event is detected can be stored in the storage unit 20.

In addition, in this exemplary embodiment, in a case where any internal event, among the first to n-th internal events, has occurred, the processing unit 10 performs a process of setting whether to transmit specific information on the internal event from the register to the memory.

That is, the specific information is written in the register even in a case where any internal event occurs, but it is possible to select (set) whether to perform transmission from the register to the memory. Specifically, the processing unit 10 transmits the specific information and the time data from the register to the memory in a case where some internal events (for example, the above-described i-th and j-th internal events) among the first to n-th internal events occur, and does not transmit the specific information and the time data from the register to the memory in a case where the other internal events (for example, the k-th internal event; k is an integer different from i and j equal to or greater than 1 and equal to or less than n) occur. A process of setting whether to store the specific information in the storage unit 20 in a case where any internal event occurs is realized by such transmission processing.

In addition, in this exemplary embodiment, the first to n-th internal events include at least two events among events indicating abnormality of a main power supply voltage of the circuit device 100, abnormality of a backup power supply voltage of the circuit device 100, and abnormality of an oscillation signal.

A main power supply is the power supply of the system including the real-time clocking device and the external device, and the voltage thereof is the main power supply voltage. A backup power supply is a power supply for operating the real-time clocking device in a case where the main power supply is not supplied (a case where the system is turned off), and the voltage is the backup power supply voltage. For example, the backup power supply is a power supply which is supplied from a primary battery, a secondary battery, a super capacitor, and the like. Examples of the abnormalities of the main power supply voltage and the backup power supply voltage include drops of the voltages, fluctuations in the voltages due to noise or the like, the voltages not being supplied to the real-time clocking device due to a mounting failure or the like, and the like. Examples of the abnormality of the oscillation signal include the stop of the oscillation signal, an oscillation frequency not being a predetermined frequency, and the like.

Specifically, the detection unit 40 includes a main power supply voltage detection unit 41 that detects the abnormality of the main power supply voltage, a backup power supply voltage detection unit 42 that detects the abnormality of the backup power supply voltage, and an oscillation signal detection unit 44 that detects the abnormality of the oscillation signal. Meanwhile, the detection unit 40 does not necessarily include the above three detection units, and the detection unit 40 may include at least two of the three detection units.

The main power supply voltage detection unit 41 compares the main power supply voltage and a first reference voltage (first threshold voltage) with each other, and changes an output signal from a non-active state (first logic level; for example, a low level, “0”) to an active state (second logic level; for example, a high level, “1”) in a case where the main power supply voltage is lower than the first reference voltage. The backup power supply voltage detection unit 42 compares the backup power supply voltage and a second reference voltage (second threshold voltage) with each other, and changes an output signal from a non-active state to an active state in a case where the backup power supply voltage is lower than the second reference voltage. For example, the main power supply voltage detection unit 41 and the backup power supply voltage detection unit 42 can be realized by a comparator. For example, the voltage of the internal power supply (an output of the power supply control unit 50 of FIG. 2) of the circuit device 100 is temporarily maintained by an external capacitor, and thus it is possible to detect a drop of the voltage by operating the comparator.

An oscillation signal or a signal based on the oscillation signal is input to the oscillation signal detection unit 44, and it is determined whether or not the oscillation signal is abnormal (whether or not the oscillation signal is stopped) on the basis of the input signal. In a case where the oscillation signal is abnormal, the output signal changes from a non-active state to an active state. For example, the oscillation signal detection unit 44 includes a smoothing circuit that smoothens the input signal to a direct current voltage level, and a comparator that compares the direct current voltage level and a third reference voltage (third threshold voltage) with each other.

According to this exemplary embodiment, it is possible to detect the occurrence of at least two events, among events indicating the abnormality of the main power supply voltage, the abnormality of the backup power supply voltage, and the abnormality of the oscillation signal as internal events and to store specific information and clocking data on the internal events. Thereby, it is possible to know in which order at least two of the abnormality of the main power supply voltage, the abnormality of the backup power supply voltage, and the abnormality of the oscillation signal have occurred. It is possible to estimate trouble (trouble related to a power supply or oscillation) which has occurred in the circuit device 100 from the time-series information thereof.

In addition, in this exemplary embodiment, specific information on an internal event is a flag indicating the occurrence of the internal event.

Specifically, there are flags corresponding to the respective first to n-th internal events, and the flags indicate that the internal events have occurred (whether or not the internal events have occurred). For example, pieces of specific information on the internal events include at least two flags among a flag indicating the occurrence of abnormality of the main power supply voltage, a flag indicating the occurrence of abnormality of the backup power supply voltage, and a flag indicating the occurrence of abnormality of the oscillation signal. The flags correspond to output signals of the main power supply voltage detection unit 41, the backup power supply voltage detection unit 42, and the oscillation signal detection unit 44 of the detection unit 40.

In this manner, the pieces of specific information on the internal events can be realized by the flags indicating whether or not the internal events have occurred. It is detected that the flags are set to be in an active state, and thus the processing unit 10 can detect the occurrence of the internal events. In this case, the flags and clocking data are stored in the storage unit 20, and thus it is possible to store the specific information and time data in the storage unit 20.

In addition, in this exemplary embodiment, an interface unit (for example, the interface unit 60 of FIG. 2) that outputs specific information and clocking data on an address, which is designated by address designation from an external device, to the external device may be provided.

In this manner, the external device has access to the storage unit 20 through the interface unit, and thus it is possible to acquire time-series information on the occurrence of the internal events. Thereby, it is possible to estimate the cause of occurrence of the internal events on the basis of the time-series information on the occurrence of the internal events.

### 2. Detailed Configuration Example of Circuit Device

FIG. 2 illustrates a detailed configuration example of the circuit device 100 according to this exemplary embodiment. The circuit device 100 includes the processing unit 10 (processing circuit), the storage unit 20 (storage circuit, memory), the clocking unit 30 (clocking circuit), the main power supply voltage detection unit 41, the backup power supply voltage detection unit 42, the power supply control unit output voltage detection unit 43, and the oscillation signal detection unit 44. In addition, the circuit device 100 includes the power supply control unit 50 (power supply control circuit), the interface unit 60 (interface circuit), an interrupt control unit 70 (interrupt control circuit), an oscillation circuit 80, a clock signal output control unit 90 (clock signal output circuit), terminals TVBAT, TVOUT, TVDD, VEVIN, TSCL, TSDA, TIRQ, TFOUT, XI, and XO. Meanwhile, the same components as the components described in FIG. 1 are denoted by the same reference numerals and signs, and a description thereof will be appropriately omitted. Here, this exemplary embodiment is not limited to the configuration of FIG. 2, and various modifications such as the omission of a portion of the components and the addition of other components can be made thereto.

A backup power supply voltage VBAT supplied from a backup power supply is input to the terminal TVBAT. A main power supply voltage VDD supplied from the main power supply is input to the terminal TVDD. The power supply control unit 50 selects the main power supply voltage VDD or the backup power supply voltage VBAT, and supplies the selected voltage to each unit of the circuit device 100 as a voltage VOUT (internal power supply voltage of the circuit device 100). Specifically, the power supply control unit selects the main power supply voltage VDD in a case where the main power supply voltage VDD exceeds a predetermined voltage, and selects the backup power supply voltage VBAT in a case where the main power supply voltage VDD is lower than the predetermined voltage. For example, the power supply control unit 50 includes a comparator that compares the main power supply voltage VDD and the predetermined voltage with each other, and an analog switch circuit of which the turn-on and turn-off are controlled on the basis of an output of the comparator.

The power supply control unit output voltage detection unit 43 detects whether or not the voltage VOUT which is an output voltage of the power supply control unit 50 is abnormal. That is, the voltage VOUT and a fourth reference voltage (fourth threshold voltage) are compared with each other. In a case where the voltage VOUT is lower than the fourth reference voltage, an output signal VLOW is changed from a non-active state (first logic level; for example, a low level, “0”) to an active state (second logic level; for example, a high level, “1”). The output signal VLOW corresponds to a flag (specific information) indicating whether or not the voltage VOUT is abnormal.

Similarly, an output signal VDET which is a detection result of the main power supply voltage detection unit 41 corresponds to a flag (specific information) indicating whether or not the main power supply voltage VDD is abnormal. An output signal VBLF which is a detection result of the backup power supply voltage detection unit 42 corresponds to a flag (specific information) indicating whether or not the backup power supply voltage VBAT is abnormal. An output signal FST which is a detection result of the oscillation signal detection unit 44 corresponds to a flag (specific information) indicating whether or not the oscillation signal is abnormal.

The processing unit 10 includes a control unit 11 that controls each unit of the circuit device 100, and an event control unit 12 that performs an event control process related to an internal event and an external event. In addition, the storage unit 20 includes a memory 21 and a register 22.

Specifically, output signals VDET, VLOW, VBLF, and FST indicating whether or not an internal event has occurred and a signal EVIN indicating whether or not an external event has occurred are input to the event control unit 12. The signal EVIN is input from the outside of the circuit device 100 through the terminal TEVIN. The event control unit 12 notifies the control unit 11 that any one of the signals has changed from a non-active state to an active state. The control unit 11 writes the output signals VDET, VLOW, VBLF, and FST in the register 22 as flags when receiving the notification, and transmits the flags and clocking data to the memory 21.

The oscillation circuit 80 is connected to one end of the resonator XTAL through the terminal XI and is connected to the other end of the resonator XTAL through the terminal XO to drive and oscillate the resonator XTAL. The oscillation circuit 80 includes an amplification circuit that drives, for example, the resonator XTAL and an adjustment circuit (for example, a capacitor array) which adjusts an oscillation frequency. Alternatively, the oscillation circuit 80 may further include a temperature sensor and a temperature compensation circuit that compensates for (suppresses) a temperature characteristic of the oscillation frequency on the basis of an output voltage of the temperature sensor.

The resonator XTAL is a piezoelectric vibrator such as a quartz crystal vibrator. Alternatively, the resonator XTAL may be a resonator (an electromechanical resonator or an electrical resonance circuit). Examples of the resonator XTAL to be adopted may include a piezoelectric vibrator, a Surface Acoustic Wave (SAW) resonator, a Micro Electro Mechanical Systems (MEMS) vibrator, and the like. Examples of a substrate material of the resonator XTAL to be used may include a piezoelectric material such as piezoelectric single crystal, for example, quartz, lithium tantalate, and lithium niobate, piezoelectric ceramics, for example, lead zirconate titanate, a silicon semiconductor material, and the like. As excitation means of the resonator XTAL, excitation means based on a piezoelectric effect may be used, or electrostatic driving based on a Coulomb force may be used.

The clocking unit 30 includes a divider 31 that performs frequency division of the oscillation signal generated by the oscillation circuit 80 to generate a clock signal having a predetermined frequency (for example, 1 kHz), a divider 32 that performs frequency division of the clock signal generated by the divider 31 to generate a clock signal of 1 Hz, and a clocking data generation unit 33 that counts the clock signals of 1 Hz to generate clocking data.

For example, the clocking data generation unit 33 includes a counter that counts clock signals of 1 Hz, and a conversion unit that converts a counted value of the counter into clocking data (data of year, month, day, hour, minute, and second). The clocking data is written in the register (or the register 22), not shown in the drawing, within the clocking data generation unit 33. An initial value of the clocking data is written through the interface unit 60 when the circuit device 100 (real-time clocking device) is first turned on, and the clocking data is updated per second, starting from the initial value.

The clock signal output control unit 90 selects any one of a plurality of clock signals (the clock signals have different frequencies) based on an oscillation signal, and outputs the selected clock signal to the outside of the circuit device 100 from the terminal TFOUT as a clock signal FOUT. In addition, the clock signal output control unit 90 can also set the clock signal FOUT to be in a non-active state (a non-output state, a stop state).

The interface unit 60 performs digital interface communication between an external device and the circuit device 100. For example, the interface unit 60 is a circuit that performs serial interface communication such as an I2C system or an SPI system. FIG. 2 illustrates a case using the I2C system, and the interface unit 60 inputs and outputs a serial data signal SDA through the terminal TSDA on the basis of a clock signal SCL which is input from the terminal TSCL.

The interrupt control unit 70 performs control for outputting an interrupt signal IRQ to an external device through the terminal TIRQ. For example, in a case where the occurrence of an internal event or the occurrence of an external event is detected by the event control unit 12, the interrupt control unit 70 sets the interrupt signal IRQ to be in an active state.

Meanwhile, the processing unit 10, the clocking unit 30, the register 22, the interface unit 60, the interrupt control unit 70, and the clock signal output control unit 90 are constituted by a logic circuit such as a gate array.

### 3. Operation of Circuit Device

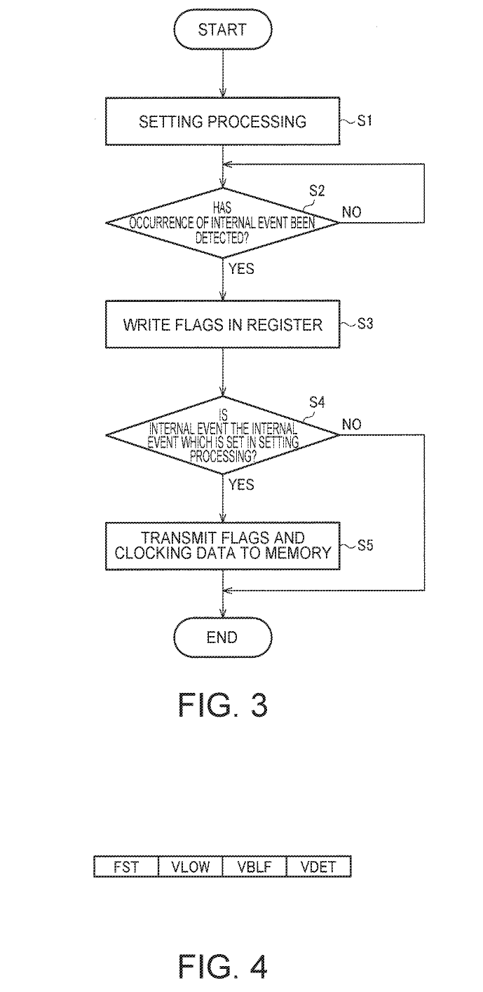

Hereinafter, the operation of the circuit device 100 of FIG. 2 will be described. FIG. 3 is a flow chart illustrating a procedure of a process of storing time-series information on the occurrence of an internal event.

As illustrated in FIG. 3, in a case where any internal event occurs, the control unit 11 performs a process of setting whether to store specific information and clocking data on an internal event in the memory 21 (S1). For example, setting information is set in the register 22 through the interface unit 60 from an external device during initialization when the circuit device 100 (real-time clocking device) is turned on, and the control unit 11 performs the setting process on the basis of the setting information.

Next, the event control unit 12 monitors the output signals VDET, VLOW, VBLF, and FST to determine whether or not the occurrence of an internal event has been detected (S2). That is, in a case where any one of the output signals VDET, VLOW, VBLF, and FST is set to be in an active state, it is determined that the occurrence of the internal event has been detected. In a case where the occurrence of the internal event has not been detected, step S2 is repeated.

In a case where the occurrence of the internal event has been detected in step S2, the control unit 11 writes the output signals VDET, VLOW, VBLF, and FST in the register 22 as flags (S3).

FIG. 4 illustrates an example of the flag stored in the register 22. In FIG. 4, each of FST, VLOW, VBLF, and VDET is a flag of one bit. For example, the flag is “1” in a case of an active state, and the flag is “0” in a case of a non-active state. Although an address is not allocated to a storage region having the flag stored therein in FIG. 4, a configuration may also be adopted in which an address is allocated to the storage region having the flag stored therein. In this case, the flag stored in the register 22 can be read out from an external device through the interface unit 60. In addition, a configuration may also be adopted in which only some flags can be read out.

Next, it is determined whether or not the internal event of which the occurrence is detected in step S2 is the internal event which is set in step S1 (S4). In a case where the internal event is not the internal event which is set in step S1, the processing is terminated without performing transmission from the register 22 to the memory 21. On the other hand, in a case where the internal event is the internal event which is set in step S1, the control unit 11 transmits the flags stored in the register 22 and the clocking data generated by the clocking data generation unit 33 to the memory 21 (S5).

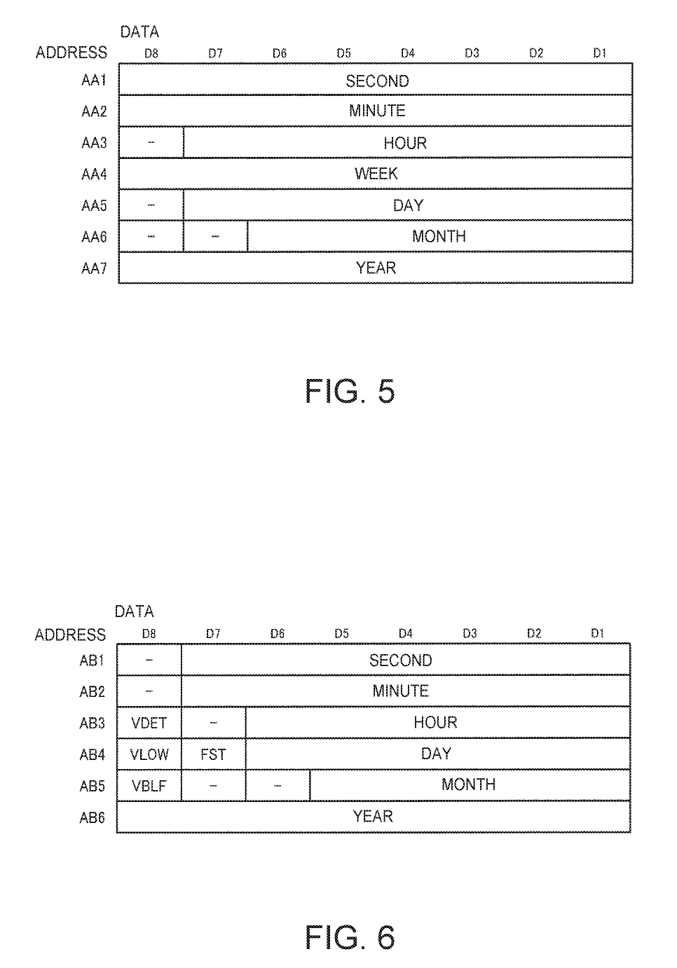

FIG. 5 illustrates an example of clocking data which is generated by the clocking data generation unit 33 and is held. A storage region of each of addresses AA1 to AA7 is 1 byte (8 bits), and D1 to D8 indicate bits of 1 byte of data. The addresses AA1, AA2, AA3, AA4, AA5, AA6, and AA7 store pieces of data of second, minute, hour, week, day, month, and year. Meanwhile, a mark “-” represents anon-use (or don't-care) bit. An external device can designate the address and have access to (read out, write) the pieces of data through the interface unit 60.

FIG. 6 illustrates an example of a flag (specific information on an internal event) and clocking data which are stored in the memory 21. A storage region of each of addresses AB1 to AB6 is 1 byte (8 bits), and D1 to D8 indicate bits of 1 byte of data. The addresses AB1, AB2, AB3, AB4, AB5, and AB6 store pieces of data of second, minute, hour, day, month, and year. In addition, the flag (VDET, VLOW, FST, VBLF) is stored in a bit which is not used for the storage of clocking data. It is possible to reduce the size of the storage region of the memory 21 by adopting such a data format. Meanwhile, the flag may be stored in a storage region of an address different from that of the clocking data.

The pieces of data of the addresses AB1 to AB6 illustrated in FIG. 6 are one set of data stored through one transmission (detection of occurrence of an internal event). Storage regions (addresses of storage regions of respective sets are different) which are capable of storing a plurality of sets of data are secured in the memory 21, and data is stored in one set's worth of storage region through each transmission. An external device can designate the address to read out the data stored in the memory 21 through the interface unit 60.

### 4. Specific Information on Internal Event

FIG. 7 illustrates an example of specific information (flag) on an internal event and an example of a state indicated by the specific information. Meanwhile, a mark “*” represents don't-care.

In a case where (FST, VLOW, VBLF, VDET)=(0, 0, 0, 0), no internal event occurs, and thus a normal state where the circuit device 100 is operated by the main power supply voltage VDD is set. In a case where (FST, VLOW, VBLF, VDET)=(0, 0, 0, 1), the main power supply voltage VDD is not supplied, but the backup power supply voltage VBAT is normal. Accordingly, a normal state where the circuit device 100 is operated by the backup power supply voltage VBAT is set.

In a case where (FST, VLOW, VBLF, VDET)=(0, *, 1, 1), the main power supply voltage VDD is not supplied, and a drop of the backup power supply voltage VBAT is detected. In this case, a voltage drop of the backup power supply voltage VBAT due to noise of the backup power supply voltage VBAT, static electricity, or the like can be assumed to be trouble.

In a case where (FST, VLOW, VBLF, VDET)=(0, 1, 0, 0), a drop of the voltage VOUT is detected regardless of the main power supply voltage VDD and the backup power supply voltage VBAT being normal. In this case, a voltage drop of the voltage VOUT due to noise of the voltage VOUT, static electricity, or the like can be assumed to be trouble.

In a case where (FST, VLOW, VBLF, VDET)=(1, 0, 0, *), the stop of oscillation is detected regardless of the voltage VOUT (that is, a power supply supplied to the oscillation circuit 80) being normal. In this case, the stop of oscillation of the oscillation circuit 80 due to a mounting failure of the resonator XTAL, a failure of the oscillation circuit 80, or the like can be assumed to be trouble.

In a case where (FST, VLOW, VBLF, VDET)=(1, 1, 0, 0), a drop of the voltage VOUT is detected regardless of the main power supply voltage VDD and the backup power supply voltage VBAT being normal, and further the stop of oscillation is detected. In this case, a mounting failure of the terminal TVOUT or a capacitor (a smoothing capacitor or a pass capacitor of the voltage VOUT) which is connected to the terminal TVOUT, or a failure of transition from the main power supply voltage VDD to the backup power supply voltage VBAT can be assumed to be trouble.

In a case where (FST, VLOW, VBLF, VDET)=(1, 0, 1, 0), a drop of the backup power supply voltage VBAT is detected, and the stop of oscillation is further detected. In this case, it can be assumed that the backup power supply voltage VBAT is not normally supplied during a backup operation, and thus non-insertion of a backup power supply (battery or the like) or a failure of contact of the backup power supply (battery or the like) can be assumed to be trouble.

In a case where (FST, VLOW, VBLF, VDET)=(1, 1, 1, 1), a state where all abnormalities have been detected is set. In this case, power-on reset being performed by the circuit device 100 due to noise of the main power supply voltage VDD, a defective backup power supply such as battery exhaustion, or a defective contact of the backup power supply (battery or the like) can be assumed to be trouble. With such a configuration of this exemplary embodiment, it is possible to more specifically specify the assumed troubles.

### 5. Real-Time Clocking Device, Electronic Apparatus, and Vehicle

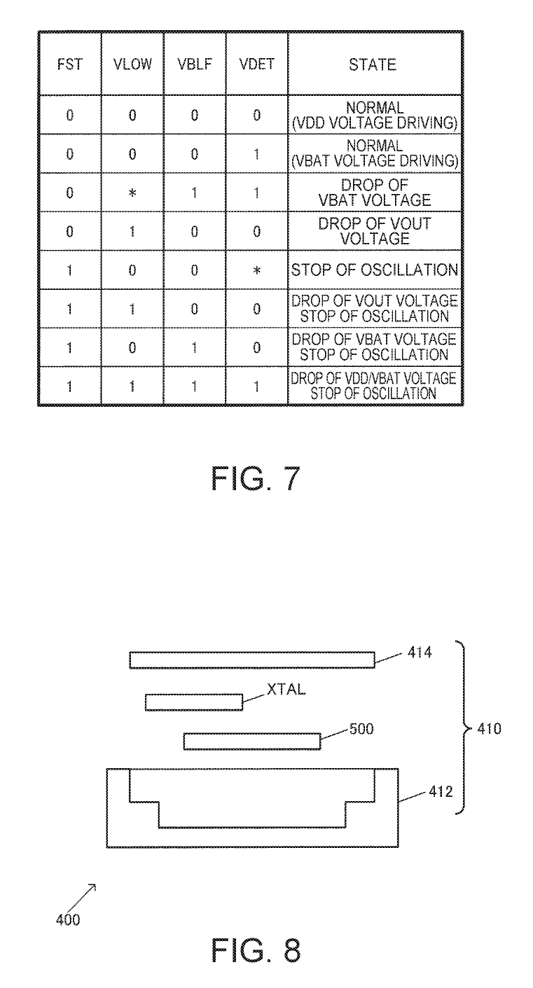

FIG. 8 illustrates a configuration example of a real-time clocking device 400 including the circuit device according to this exemplary embodiment. The real-time clocking device 400 includes a circuit device 500 (corresponding to the circuit device 100 of FIG. 1 or FIG. 2), and a resonator XTAL (vibrator, vibrator element). In addition, the real-time clocking device 400 may include a package 410 that accommodates the circuit device 500 and a resonator XTAL. Meanwhile, the real-time clocking device is not limited to the configuration of FIG. 8, and various modifications such as the omission of a portion of the components and the addition of other components can be made thereto.

The package 410 includes, for example, a base portion 412 and a lid portion 414. The base portion 412 is, for example, a box-shaped member including an insulating material such as ceramic, and the lid portion 414 is, for example, a flat plate-shaped member which is bonded to the base portion 412. For example, the bottom surface of the base portion 412 is provided with an external connection terminal (external electrode) for connection to an external apparatus. The circuit device 500 and the resonator XTAL are accommodated in an inner space (cavity) formed by the base portion 412 and the lid portion 414. The circuit device 500 and the resonator XTAL are airtightly sealed in the package 410 by the lid portion 414. The circuit device 500 and the resonator XTAL are mounted within the package 410. A terminal of the resonator XTAL and a terminal (pad) of the circuit device 500 (IC) are electrically connected to each other by an internal wiring of the package 410.

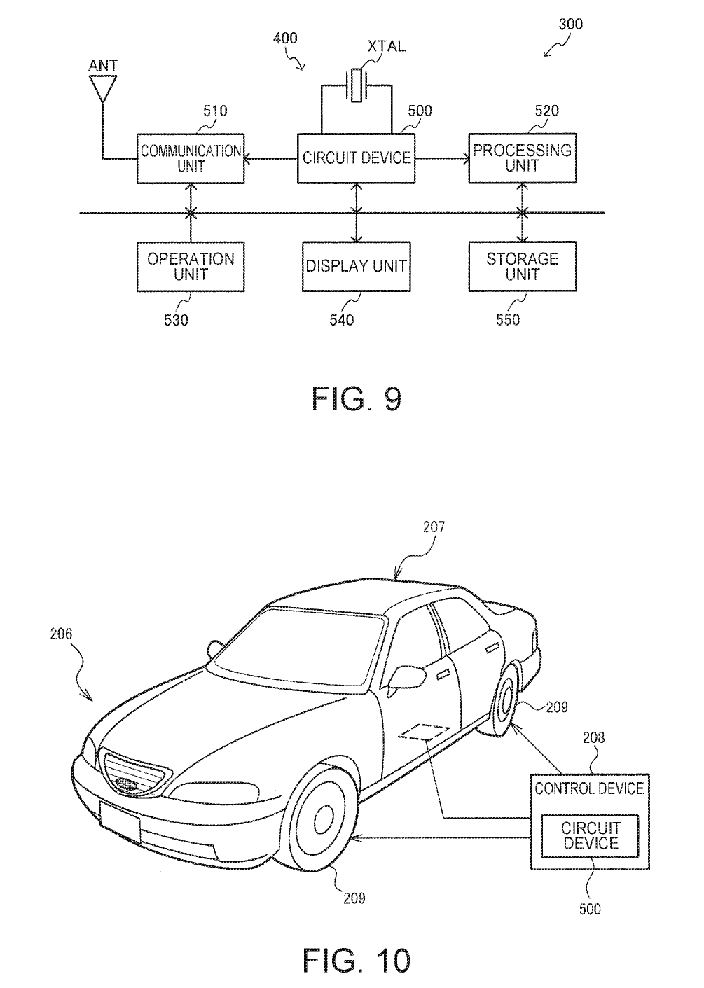

FIG. 9 illustrates a configuration example of an electronic apparatus 300 including the circuit device according to this exemplary embodiment. The electronic apparatus 300 includes a circuit device 500, a resonator XTAL such as a quartz crystal vibrator, an antenna ANT, a communication unit 510 (communication device), and a processing unit 520 (processing device). In addition, the electronic apparatus may include an operation unit 530 (operation device), a display unit 540 (display device), and a storage unit 550 (memory). The real-time clocking device 400 is constituted by the resonator XTAL and the circuit device 500. Meanwhile, the electronic apparatus 300 is not limited to the configuration of FIG. 9, and various modifications such as the omission of a portion of the components and the addition of other components can be made thereto.

Examples of the electronic apparatus 300 of FIG. 9 which are to be assumed may include an on-vehicle electronic device such as an Electronic Control Unit (ECU) or a meter panel, a video apparatus such as a digital camera or a video camera, and a printing apparatus such as a printer or a multi-function printer. Alternatively, it is possible to assume various apparatuses, for example, a wearable apparatus such as a GPS-incorporated time piece, a biological information measurement apparatus (a pulse wave meter, a pedometer, or the like) or a head-mounted display device, a portable information terminal (mobile terminal) such as a smartphone, a mobile phone, a portable game device, a notebook PC, or a tablet PC, a content provision terminal that distributes a content, and a network-related apparatus such as a base station or a router.

The communication unit 510 (wireless circuit) performs a process of receiving data from the outside through the antenna ANT and transmitting data to the outside. The processing unit 520 performs control processing of the electronic apparatus 300, various digital processing of data transmitted and received through the communication unit 510, and the like. The function of the processing unit 520 can be realized by a processor such as a micro-computer. The operation unit 530 is a unit for causing a user to perform an input operation, and can be realized by an operation button, a touch panel display, or the like. The display unit 540 is a unit for displaying various pieces of information, and can be realized by a display such as a liquid crystal display or an organic EL. Meanwhile, in a case where a touch panel display is used as the operation unit 530, the touch panel display can also serve as the operation unit 530 and the display unit 540. The storage unit 550 stores data, and the function thereof can be realized by a semiconductor memory such as a RAM or a ROM, a hard disk drive (HDD), or the like. The electronic apparatus 300 may include, for example, a sensor (for example, a hall element or the like) which detects that the housing of the electronic apparatus 300 is opened. An output signal of the sensor may be input to the circuit device 500 as an external event signal (EVIN of FIG. 2). Thereby, in a case where the housing of the electronic apparatus 300 is opened, the time stamp (clocking data) thereof and specific information of an event (specific information on an external event and an internal event) can be recorded in the memory of the circuit device 500.

FIG. 10 illustrates an example of a vehicle including the circuit device according to this exemplary embodiment. The circuit device 500 (real-time clocking device) according to this exemplary embodiment can be embedded in various vehicles such as a car, an airplane, a motorcycle, a bicycle, and a ship. The vehicle is an apparatus or a device that moves on the ground and in the sky and the sea by including a driving mechanism such as an engine or a motor, a steering mechanism such as a handle or a rudder, and various electronic apparatuses (on-vehicle apparatus). FIG. 10 schematically illustrates an automobile 206 as a specific example of the vehicle. A real-time clocking device (not shown) including the circuit device 500 according to this exemplary embodiment and a vibrator is embedded in the automobile 206. A control device 208 operates on the basis of clocking data generated by the real-time clocking device. For example, the control device 208 may be an ECU that controls hardness and softness of a suspension in accordance with the posture of a vehicle body 207, and controls braking of individual wheels 209. For example, the automatic driving of the automobile 206 may be realized by the control device 208. Alternatively, the control device 208 may be a meter panel that displays the speed of the vehicle, a remaining amount of fuel, and the like. Similarly to the method described in the electronic apparatus 300, the time stamp thereof and specific information of an event can be recorded in the memory of the circuit device 500 in a case where the meter panel is opened fraudulently (or during regular examination). Thereby, it is possible to know a possibility such as distortion of the meter panel. Meanwhile, an apparatus having the circuit device or the real-time clocking device according to this exemplary embodiment embedded therein is not limited to the control device 208, and the circuit device or the real-time clocking device can be embedded in various apparatuses (on-vehicle apparatuses) provided in vehicles such as the automobile 206.

While this exemplary embodiment has been described in detail, one skilled in the art can easily understand that a number of modifications can be made without substantially departing from the new matters and effects of the invention. Therefore, all such modifications are included in the scope of the invention. For example, a term described at least once along with a different term having a broader meaning or the same meaning in the description or drawings can be replaced with the different term at any location in the description or drawings. In addition, all combinations of this exemplary embodiment and the modification examples are included in the scope of the invention. In addition, the configurations and operations of the circuit device, the real-time clocking device, the electronic apparatus, and the vehicle, and the like are not limited to those described in this exemplary embodiment and can be modified in various ways.

The entire disclosure of Japanese Patent Application No. 2017-008030, filed Jan. 20, 2017 is expressly incorporated by reference herein.

What is claimed is:

1. A circuit device comprising:
a processing circuit configured to detect occurrence of an internal event of the circuit device;
a storage circuit; and
a clocking circuit configured to generate clocking data which is real-time clock information based on an oscillation signal,
wherein the processing circuit stores specific information on the internal event and the clocking data when the occurrence of the internal event is detected, in the storage circuit when the occurrence of the internal event is detected.

2. The circuit device according to claim 1,
wherein in a case where occurrence of an i-th internal event (i is an integer of equal to or greater than 1 and equal to or less than n) among first to n-th internal events (n is an integer of 2 or greater) is detected, the processing circuit stores information for specifying the occurrence of at least the i-th internal event in the storage circuit as the specific information.

3. The circuit device according to claim 2,
wherein the j-th internal event (j is an integer of equal to or greater than 1 and equal to or less than n, and is an integer different from i) among the first to n-th internal events occurs after the i-th internal event occurs, the processing circuit stores information for specifying the occurrence of the j-th internal event in a storage region of an address different from an address in which the information for specifying the occurrence of the i-th internal event is stored.

4. The circuit device according to claim 2,
wherein the processing circuit performs a process of setting whether to store the specific information in the storage circuit in a case where each of the first to n-th internal events occurs.

5. The circuit device according to claim 2,
wherein the first to n-th internal events include at least two events among events indicating abnormality of a main power supply voltage of the circuit device, abnormality of a backup power supply voltage of the circuit device, and abnormality of an oscillation signal.

6. The circuit device according to claim 1,
wherein the specific information on the internal event is a flag representing occurrence of the internal event.

7. The circuit device according to claim 1, further comprising:
an interface circuit configured to output the specific information and the clocking data of an address, which is designated by address designation from an external device, to the external device.

8. The circuit device according to claim 1,
wherein the storage circuit includes a register and a memory, and
wherein the processing circuit writes the specific information in the register in a case where the occurrence of the internal event is detected, and transmits the specific information written in the register to the memory.

9. The circuit device according to claim 8,
wherein the processing circuit performs a process of setting whether to transmit the specific information from the register to the memory in a case where any internal event among the first to n-th internal events (n is an integer of 2 or greater) occurs.

10. A real-time clocking device comprising:
the circuit device according to claim 1; and
a resonator.

11. An electronic apparatus comprising the circuit device according to claim 1.

12. A vehicle comprising the circuit device according to claim 1.
